(19) United States
(12) Patent Application Publication
(10) Pub. No.: US 2010/0329660 A1
(43) Pub. Date: Dec. 30, 2010

(54) DIGITAL MOVING PICTURE PHOTOGRAPHING APPARATUS, METHOD OF CONTROLLING THE APPARATUS, RECORDING MEDIUM STORING PROGRAM TO EXECUTE THE METHOD, AND METHOD OF DETERMINING MOVEMENT OF SUBJECT

(75) Inventors: San-joung Cho, Suwon-si (KR); Su-jin Ryu, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Electronics Co., Ltd., Suwon-si (KR)

(21) Appl. No.: 12/719,179

(22) Filed: Mar. 8, 2010

(30) Foreign Application Priority Data
Mar. 9, 2009 (KR) 10-2009-0019841

(51) Int. Cl. G03B 17/00

(52) U.S. Cl. 396/263

(57) ABSTRACT

A digital moving picture photographing apparatus is provided for increasing user convenience by excluding unnecessary parts of a recording moving picture and starting/stopping a photographing operation automatically, as is an appertaining method and computer readable recording with code to implement the method. The digital moving picture photographing apparatus includes: an image capture device for generating image data from incident light; and a storage medium for storing the image data generated by the image capture device. The method includes: starting storing data of frame images, when a movement of a subject is sensed from the frame images of image data generated by the image capture device in a shooting mode; and stopping the recording of the moving picture when the movement of the subject is not sensed from the frame images of the image data generated by the image capture device during storing of the frame images in the storage medium.

### CROSS-REFERENCE TO RELATED PATENT APPLICATION

This application claims the benefit of Korean Patent Application No. 10-2009-0019841, filed on Mar. 9, 2009, in the Korean Intellectual Property Office, the disclosure of which is incorporated herein in its entirety by reference.

### BACKGROUND

The present invention relates to a digital moving picture photographing apparatus, a method of controlling the digital moving picture photographing apparatus, a recording medium having recorded thereon a program for executing the method, and a method of determining movement of a subject, and more particularly, to a digital moving picture photographing apparatus which does not photograph unnecessary portions of recorded moving picture while taking moving pictures, or starts/stops photographing automatically to increase user convenience, a method of controlling the digital moving picture photographing apparatus, a recording medium having recorded thereon a program for executing the method, and a method of determining movement of a subject.

In general, digital moving picture photographing apparatuses start or stop capturing moving pictures at a signal from a user.

According to conventional digital moving picture photographing apparatuses, a user generally photographs scenes, objects, or other people by manipulating the digital moving picture photographing apparatus. Thus, in order for the user to capture moving pictures of himself/herself, he/she manipulates the digital moving picture photographing apparatus to start photographing and moves to a position in front of the digital moving picture photographing apparatus. Then, in order to stop the moving picture photographing operation, the user moves to the digital moving picture photographing apparatus again to manipulate the digital moving picture photographing apparatus. Therefore, in taken moving pictures, unnecessary parts, that is, scenes where the user moves from/to the digital moving picture photographing apparatus, are included

### SUMMARY

The present invention provides a digital moving picture photographing apparatus which does not photograph unnecessary portions of recorded moving picture while taking moving pictures, or starts/stops photographing automatically to increase user convenience, a method of controlling the digital moving picture photographing apparatus, a recording medium having recorded thereon a program for executing the method, and a method of determining movement of a subject.

According to an aspect of the present invention, there is provided a digital moving picture photographing apparatus including: an image capture device for generating image data from incident light; and a storage medium for storing the image data generated by the image capture device, wherein, in a shooting mode, when a movement of a subject is sensed from frame images in the image data generated by the image capture device, storing of the image data of the frame images may be started in the storage medium, and when the movement of the subject is not sensed from the frame images in the image data generated by the image capture device, during storing of the frame images in the storage medium, recording of the moving picture may be stopped.

A boundary image of the subject in a first frame image and a boundary image of the subject in a second frame image may be compared with each other, and when there is a difference between the boundary images, it may be determined that the movement of the subject is sensed, and when there is no difference between the boundary images, it may be determined that the movement of the subject is not sensed.

First points may be defined as points where a contour line of the subject image in the first frame is bent, and second points may be defined as points where a contour line of the subject image in the second frame is bent, locations of the first points and corresponding second points may be compared with each other, and when a difference between at least one first point and the corresponding second point is equal to or greater than a predetermined degree, it may be determined that the movement of the subject is sensed.

Data values at points which are set in advance in the first frame image and data values at points which are set in advance to correspond to the points of the first frame image in the second frame image may be compared with each other, and when a difference between data values of at least one point is equal to or greater than a predetermined value, it may be determined that the movement of the subject is sensed.

In a shooting mode, even when the movement of the subject is sensed from the frame images of the image data generated by the image capture device, storing of the frame images data in the storage medium may be started after a predetermined time period.

In a shooting mode, after a predetermined time period, when the movement of subject is sensed from the frame images of the image data generated by the image capture device, storing of the frame image data in the storage medium may be started.

According to another aspect of the present invention, there is provided a method of controlling a digital moving picture photographing apparatus comprising: generating image data with an image capture device from incident light; storing the image data generated by the image capture device in a storage medium; sensing movement of a subject from the frame images of image data generated by the image capture device in a shooting mode; starting storing data of frame images when the movement of the subject is sensed; and stopping recording of the moving picture when the movement of subject is not sensed during the storing of the frame images in the storage medium.

A boundary image of the subject in a first frame image and a boundary image of the subject in a second frame image may be compared with each other, and determining that subject movement is sensed when there is a difference between the boundary images, and determining that subject movement is not sensed when there is no difference between the boundary images.

Using the above definition of first and second points, locations of the first points and corresponding second points may be compared with each other, and when a difference between at least one first point and the corresponding second point is equal to or greater than a predetermined degree, it may be determined that the movement of the subject is sensed.

Data values at points which are set in advance in the first frame image and data values at points which are set in advance to correspond to the points of the first frame image in the second frame image may be compared with each other, and when a difference between data values of at least one point is equal to or greater than a predetermined value, it may be determined that the movement of the subject is sensed.

In a shooting mode, even when the movement of the subject from the frame images of the image data generated by the image capture device is sensed, the method may start storing of the frame images data in the storage medium after a predetermined time period.

In a shooting mode, after a predetermined time period, when the movement of the subject is sensed from the frame images of the image data generated by the image capture device, the method may start storing of the frame image data in the storage medium.

According to another aspect of the present invention, there is provided a computer readable recording medium having embodied thereon computer readable program code adapted to be executed to implement the above method.

According to another aspect of the present invention, there is provided a method of determining a movement of a subject, the method including, using the above definitions for first and second points, comparing locations of the first points and corresponding second points with each other, and when a difference between at least one first point and the corresponding second point is equal to or greater than a predetermined degree, determining that the movement of the subject is sensed.

According to another aspect of the present invention, there is provided a method of determining a movement of a subject, the method including, comparing data values at points which are set in advance in the first frame image and data values at points which are set in advance to correspond to the points of the first frame image in the second frame image with each other, and when a difference between data values of at least one point is equal to or greater than a predetermined value, determining that the movement of the subject is sensed.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a digital moving picture photographing apparatus according to an embodiment of the present invention;

FIGS. 2A and 2B are pictorial conceptual views illustrating two frame images according to an embodiment of the present invention;

FIGS. 3A through 3C are pictorial conceptual views illustrating a method of determining movement of a subject according to an embodiment of the present invention;

FIGS. 4A and 4B are pictorial conceptual views illustrating a method of determining movement of a subject according to another embodiment of the present invention;

FIG. 5 is a flowchart of a method of controlling a digital moving picture photographing apparatus, according to an embodiment of the present invention;

FIG. 6 is a flowchart of a method of controlling a digital moving picture photographing apparatus, according to another embodiment of the present invention; and

FIG. 7 is a flowchart of a method of controlling a digital moving picture photographing apparatus, according to another embodiment of the present invention.

### DETAILED DESCRIPTION OF THE EMBODIMENTS

Hereinafter, exemplary embodiments of the invention will be described in detail with reference to the appended drawings.

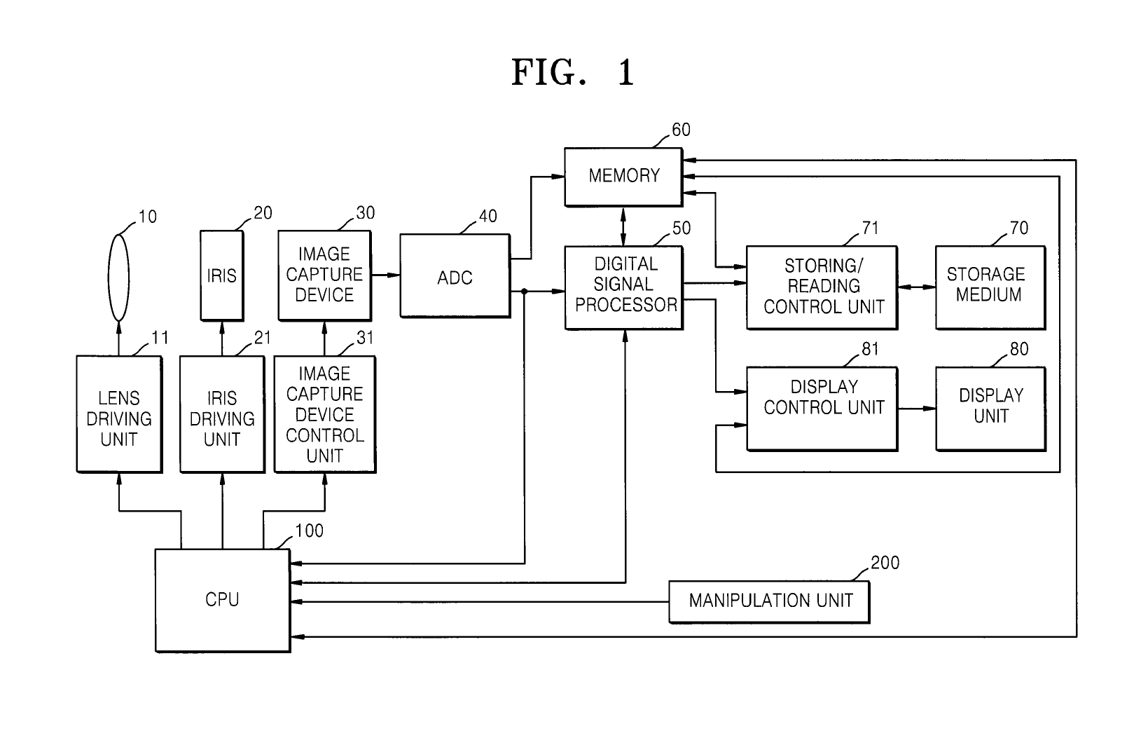

FIG. 1 is a schematic block diagram of a digital moving picture photographing apparatus according to an embodiment of the present invention;

All operations of the digital moving picture photographing apparatus are controlled by a central processing unit (CPU) 100. The digital moving picture photographing apparatus includes a manipulation unit 200 having a key generating an electrical signal in response to a user's instruction. An electrical signal generated by the manipulation unit 200 is transmitted to the CPU 100 so that the CPU 100 can control the digital moving picture photographing apparatus in response to the electrical signal.

In a shooting mode, as an electrical signal generated in response to a user's instruction is input to the CPU 100, the CPU 100 analyzes the electrical signal and controls a lens driving unit 11, an iris driving unit 21, and an image capture device control unit 31, thus controlling the position of a lens 10, the degree of openness of an iris 20, and the sensitivity of an image capture device 30. The image pickup device 30 generates image data from incident light. An analog/digital (A/D) converting unit (ADC) 40 converts analog data output from the image pickup device 30 into digital data. The ADC 40 may not be included depending on the characteristics of the image capture device 30.

Data output from the image capture device 30 is provided to a digital signal processing unit 50 via a memory 60 or by bypassing the memory 60. The data output from the image capture device 30 may also be provided to the CPU 100 if necessary. In the present embodiment, the memory 60 may include a read-only memory (ROM) or a random access memory (RAM). The digital signal processing unit 50 can perform digital signal processing, such as gamma correction, white balance correction, and the like, if necessary.

The image data output from the digital signal processor 50 is transmitted to a display control unit 81 directly or via the memory 60. The display control unit 81 controls a display unit 80 to display an image on the display unit 80. In addition, the data output from the digital signal processor 50 is input to a storage/read controller 71 directly or via the memory 60. The storing/reading control unit 71 stores data in a storage medium 70 automatically or according to a signal from the user. That is, the storage medium 70 stores the data generated by the image capture device 30. Alternatively, the storing/reading control unit 71 may read the image data from moving picture file stored in the storage medium 70, and provide the read data to the display control unit 81 via the memory 60 or via another path so that an image is displayed on the display unit 80. The storage medium 70 may be attachable to and detachable from the digital photographing apparatus. Alternatively, the storage medium 70 may be permanently built in the digital moving picture photographing apparatus.

The digital moving picture photographing apparatus starts storing frame image data in the storage medium 70 when sensing movements of subjects in the frame images of the data generated by the image capture device 30 in the shooting mode. In addition, while storing the frame images in the storage medium 70, the digital moving picture photographing apparatus stops moving picture photographing when the movement of the subject in the frame images of the data generated by the image capture device 30 is not sensed.

According to the digital moving picture photographing apparatus of the present embodiment, the moving picture photographing is started when the digital moving picture photographing apparatus senses movement of the subject even if the user does not manipulate the digital moving picture photographing apparatus so as to start the photographing operation. Here, starting of the moving picture photographing operation denotes that frame images are started to be stored in the storage medium 70. In general, the digital moving picture photographing apparatus displays frame images on the display unit 80 even when the frame images are not stored in the storage medium 70, and the digital moving picture photographing apparatus of the present embodiment starts storing the frame images in the storage medium on sensing the movement of the subject by using the frame images to start the photographing operation. Therefore, user convenience may be maximized. Moreover, when the movement of the subject in the frame images is not sensed while storing the frame images in the storage medium 70, the moving picture photographing operation is stopped. As described above, the user does not need to manipulate the digital moving picture photographing apparatus directly in order to stop the photographing operation, and thus, user convenience may be increased.

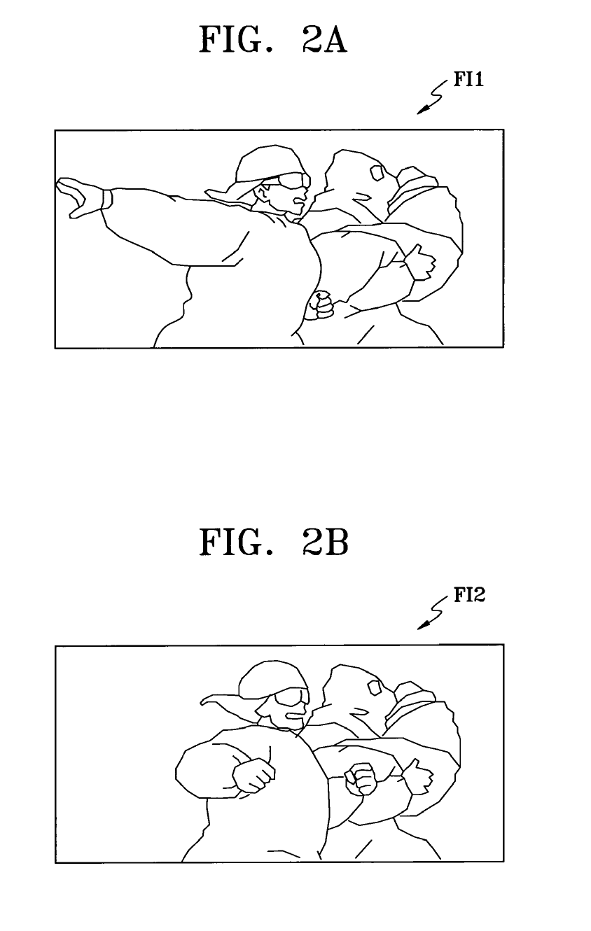

FIGS. 2A and 2B are pictorial conceptual views illustrating two frame images according to an embodiment of the present invention. A first frame image FI1 and a second frame image FI2 may be frame images closest to each other in terms of time, or may be adjacent to each other even when they are not successive. As shown in FIGS. 2A and 2B, when the digital moving picture photographing apparatus of the present embodiment senses the movement of a subject by comparing the first frame image FI1 and the second frame image F12 with each other in the shooting mode, the digital moving picture photographing apparatus starts storing data of the frame images FI1 and FI2 in the storage medium 70. That is, the digital moving picture photographing apparatus starts recording moving pictures.

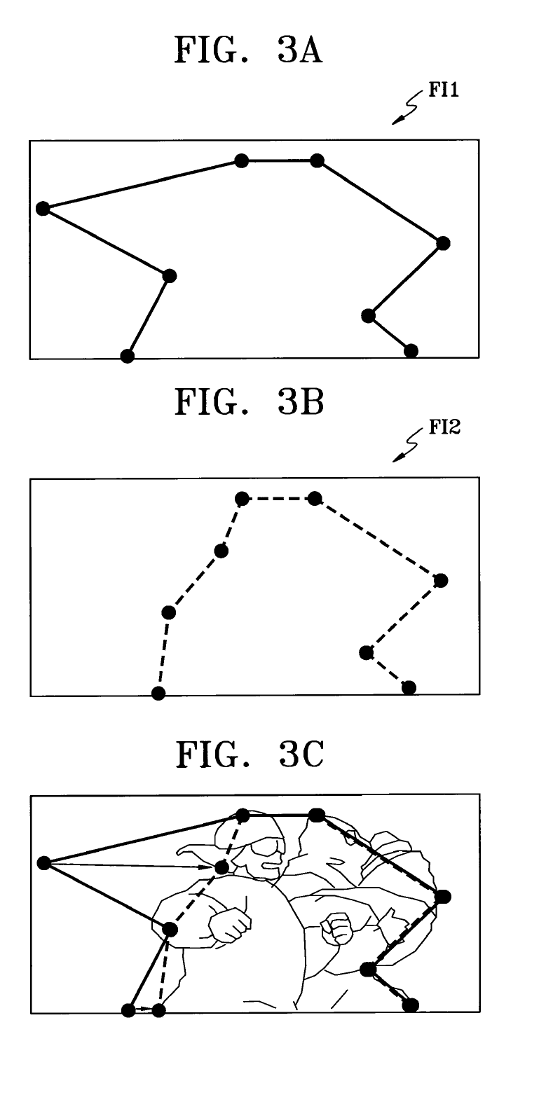

FIGS. 3A through 3C are pictorial conceptual views illustrating a method of determining movement of a subject in two frame images as shown in FIGS. 2A and 2B according to an embodiment of the present invention. Referring to FIGS. 3A through 3C, the digital moving picture photographing apparatus compares a boundary image of the subject in the first frame image FI1 with a boundary image of the subject in the second frame image FI2, and determines that the subject has moved when there is a difference between the boundary images in the first and second frame images FI1 and FI2 and determines that the subject has not moved when there is no difference between the boundary images in the first and second frame images FI1 and FI2. In more detail, when it is assumed that points where a contour of the boundary image of the subject in the first frame image FI1 is bent are referred to as first points and points where a contour of the boundary image of the subject in the second frame image FI2 is bent are referred to as second points, locations of the first points and second points corresponding to each other are compared with each other. Then, when a dislocation between at least one first point and corresponding second point is equal to or greater than a predetermined degree, it is determined that the digital moving picture photographing apparatus senses a movement of the subject.

FIG. 3A shows a line representing the boundary of the image of the subject and the first points where the line is bent in the first frame image FI1 shown in FIG. 2A. FIG. 3B shows a line representing the boundary of the image of the subject and the second points where the line is bent in the second frame image FI2 shown in FIG. 2B. FIG. 3C illustrates relations between locations of the first points and the second points in FIGS. 3A and 3B, and as shown in FIG. 3C, when the locations of the corresponding first points and second points are compared with each other, it is determined that locations of two first points and corresponding second points are different from each other. When the dislocation occurs, it may be determined that the subject has moved from the first frame image FI1 to the second frame image FI2.

If the subject slightly moves, it may be determined that there is no movement of the subject. To this end, when the difference between at least one first point and corresponding second point is equal to or greater than a predetermined degree, it is determined that the movement of the subject is sensed.

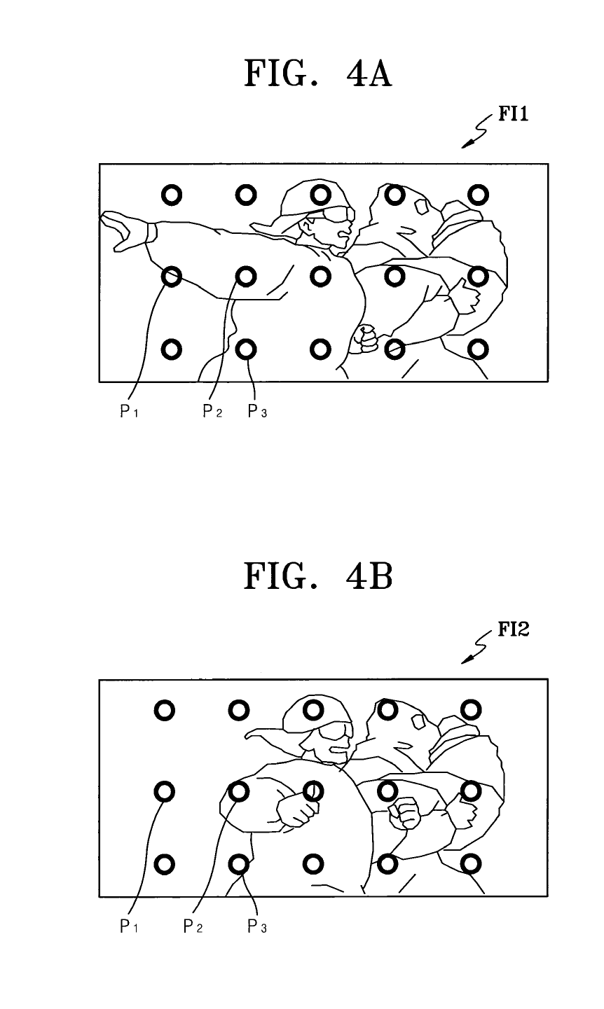

FIGS. 4A and 4B are pictorial conceptual views illustrating a method of determining movement of the subject in two frame images shown in FIGS. 2A and 2B according to another embodiment of the present invention. Referring to FIGS. 4A and 4B, data values at points which are set in advance in the first frame image FI1 and data values at points which are the same locations as those of the first frame image FI1 in the second frame image FI2 are compared with each other, and then, when there is a difference between the data values of the first and second frame images FI1 and FI2 for at least one point, it is determined that the digital moving picture photographing apparatus senses the movement of the subject. Referring to FIGS. 4A and 4B, the data values of the first frame image FI1 and the data values of the second frame image FI2 at 15 points which are set in advance are compared with each other, and there are differences between the data values of the first and second frame images FI1 and FI2 at the points denoted as P₁ through P₃. Then, it is determined that the subject moves between the first frame image FI1 and the second frame image FI2.

If the subject slightly moves, it may be determined that there is no movement of the subject. To this end, the data values at the points which are set in advance in the first frame image FI1 and the data values at the points which are the same as the points of the first frame image FI1 in the second frame image FI2 are compared with each other, and then, when a difference between the data values of at least one point and the corresponding point is equal to or greater than a predetermined value, it may be determined that the subject has moved between the first frame image FI1 and the second frame image FI2.

The method of determining whether the subject moves or not, which is performed by the digital moving picture photographing apparatus of the present embodiment, is not limited to the methods described with reference to FIGS. 3A through 4B.

When the moving picture is recorded by using a conventional digital moving picture photographing apparatus, a user manipulates the apparatus so as to start the photographing operation and then moves to a position in front of the apparatus in order to photograph himself/herself. In addition, the user moves toward the apparatus again and manipulates the apparatus in order to stop the photographing operation. Therefore, the recorded moving picture includes unnecessary parts, for example, the user moving from the apparatus or moving toward the apparatus.

According to the digital moving picture photographing apparatus of the present embodiment, in the shooting mode, even when the movement of the subject is sensed in the frame images from the image data generated by the image capture device 30, data of frame images after a predetermined time has elapsed may be stored in the storage medium 70. If the user moves to a position in front of the digital moving picture photographing apparatus of the present embodiment after manipulating the apparatus to start the photographing operation, the digital moving picture photographing apparatus may determine that the movement of the subject occurs, and then, may start storing the frame images in the storage medium 70. In this case, the recorded moving picture may include unnecessary parts. Therefore, to prevent the above problem, the digital moving picture photographing apparatus may be set to start storing the data of frame images in the storage medium 70 after a predetermined time has elapsed even when the movement of the subject is sensed from the frame images of the image data generated by the image capture device 30.

Also, as a modified example, in the shooting mode, when the movement of the subject from the frame images of the data generated by the image capture device 30 is sensed after a predetermined time has elapsed, the digital moving picture photographing apparatus may start storing the data of the frame images in the storage medium 70. That is, the movement of the subject in the frame images may not be determined within the predetermined time period.

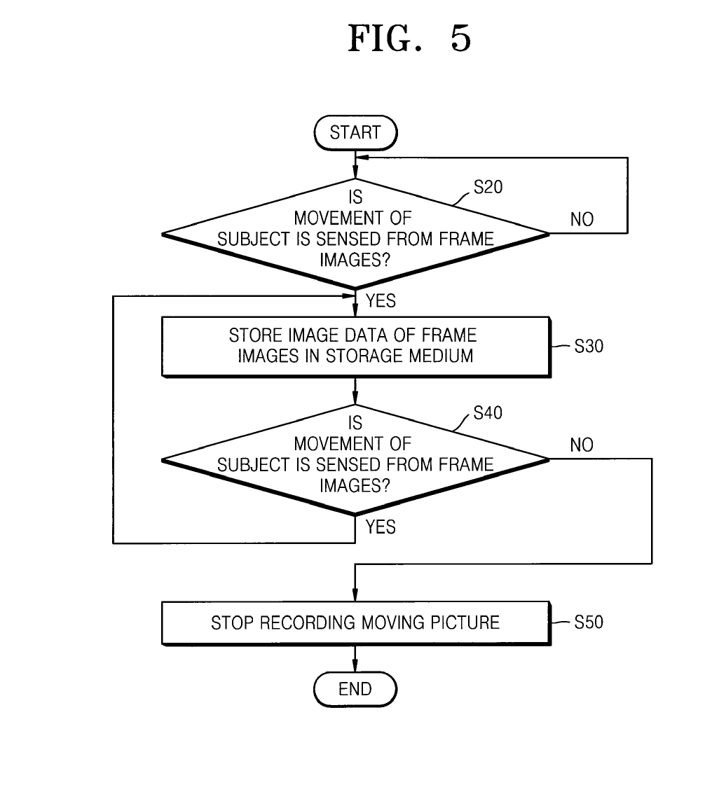

FIG. 5 is a flowchart illustrating a method of controlling the digital moving picture photographing apparatus including an image capture device generating data from incident light and a storage medium storing the data generated by the image capture device, according to an embodiment of the present invention.

In FIG. 5, ‘start’ means start of the shooting mode. Referring to FIG. 5, in operation S20, it is determined whether movement of a subject is sensed or not from frame images of image data generated by the image capture device. If the movement of the subject is sensed, storing of image data of the frame images is started in the storage medium in operation S30. In addition, in operation S40, it is determined whether the movement of the subject is sensed in the frame images, and, if the movement of the subject is sensed, the image data of the frame images is stored in the storage medium in operation S30. The above operations are repeated. If the movement of the subject is not sensed from the frame images of the data generated by the image capture device in operation S40 while storing the frame images in the storage medium, the recording of the moving pictures is stopped. Therefore, the storing of frame images may be automatically started or stopped by sensing the movement of the subject, and thus, user convenience may be improved greatly.

The operation of determining whether the subject moves or not may be performed by using various methods. For example, a boundary image of the subject in the first frame image and a boundary image of the subject in the second frame image are compared with each other, and it is determined that the subject has moved when there is a difference between the boundary images and that the subject has not moved when there is no difference between the boundary images. In more detail, when it is assumed that points where a contour of the boundary image of the subject in the first frame image is bent are referred to as first points and points where a contour of the boundary image of the subject in the second frame image is bent are referred to as second points, locations of the first points and second points corresponding to each other are compared with each other. Then, when a dislocation between at least one first point and corresponding second point is equal to or greater than a predetermined degree, it is determined that the digital moving picture photographing apparatus senses the movement of the subject. In addition, data values at points which are set in advance in the first frame image and data values at points which are the same locations as those of the first frame image in the second frame image are compared with each other, and then, when a difference between the data values of the first and second frame images and of at least one point is equal to or greater than a predetermined value, it is determined that the digital moving picture photographing apparatus senses the movement of the subject.

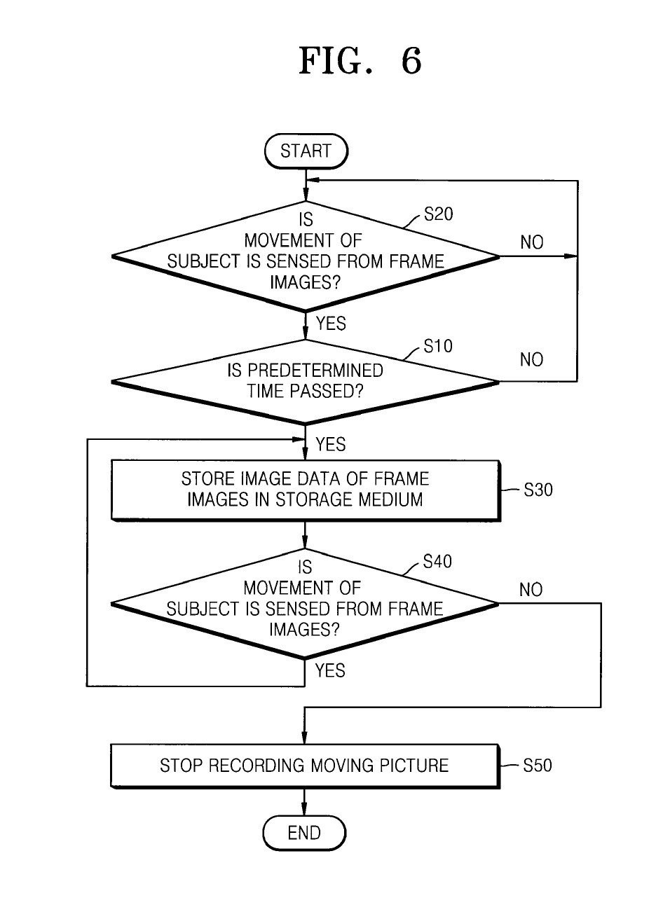

FIG. 6 is a flowchart of a method of controlling a digital moving picture photographing apparatus, according to another embodiment of the present invention. The method of the present embodiment is different from the method described with reference to FIG. 5 in that even when the movement of the subject is sensed after operation S20, in which it is determined whether the movement of the subject is sensed from the frame images of the data generated by the image capture device, operation S10 is performed, in which it is determined whether a predetermined time has elapsed or not. Only when the predetermined time has elapsed, is operation S30 for starting storing of the frame image data in the storage medium performed. That is, even when the movement of the subject is sensed from the frame images of the data generated by the image capture device, the image data of the frame images is stored after the predetermined time has elapsed.

According to the conventional method of controlling the digital moving picture photographing apparatus, in order to include the user of the digital moving picture photographing apparatus adopting the conventional controlling method in the moving picture, the user manipulates the apparatus in order to start the photographing apparatus and moves to a position in front of the apparatus. Therefore, the recorded moving picture includes the unnecessary part, for example, the user moving from the apparatus to the position in front of the apparatus. However, according to the method of controlling the digital moving picture photographing apparatus of the present embodiment, even when the movement of the subject from the frame images of the data generated by the image capture device is sensed, the storing of the frame image data in the storage medium is started after a predetermined time period, and thus, the unnecessary part is not included in the recorded moving picture.

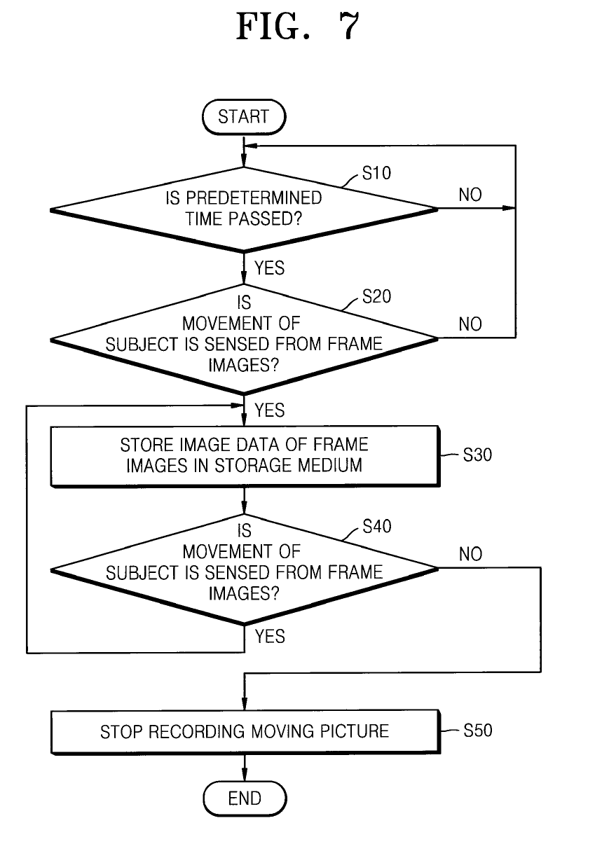

FIG. 7 is a flowchart of a method of controlling a digital moving picture photographing apparatus, according to another embodiment of the present invention. The method of the present embodiment is different from the method described with reference to FIG. 5 in that the operation S10, in which it is identified whether the predetermined time has elapsed or not, is performed, and then, it is determined whether the movement of the subject is sensed from the frame images in operation S20 after the predetermined time has elapsed. That is, after the predetermined time period, when the movement of the subject is sensed from the frame images of the data generated by the image capture device, the storing of the frame image data in the storage medium is started.

According to the conventional method of controlling the digital moving picture photographing apparatus, in order to include the user of the digital moving picture photographing apparatus adopting the conventional controlling method in the moving picture, the user manipulates the apparatus in order to start the photographing apparatus and moves to a position in front of the apparatus. Therefore, the recorded moving picture includes an unnecessary part, for example, the user moving from the apparatus to a position in front of the apparatus. However, according to the method of controlling the digital moving picture photographing apparatus of the present embodiment, after the predetermined time has elapsed, when the movement of the subject is sensed from the frame images of the data generated by the image capture device, the storing operation of the frame image data is started. Therefore, the unnecessary part is not included in the recorded moving picture.

A program that executes the controlling method in the digital moving picture photographing apparatus, according to the above embodiment of the present invention and/or modified examples thereof may be stored in a recording medium. For example, the recording medium may be embodied as the storage medium 70 or the memory 60 of FIG. 1, or as an additional type of recording medium. The recording medium may be another type of storage medium that may be, for example, a magnetic storage medium (a read-only memory (ROM), a floppy disk, a hard disc, and the like, for example), and an optical storage medium (a compact disc (CD)-ROM, a digital versatile disc (DVD), and the like, for example).

In addition, the method of determining the movement of the subject in the moving picture may be applied to various image processing devices such as personal digital assistants (PDAs) or personal multimedia players (PMPs), as well as the digital moving picture photographing apparatus.

That is, when it is assumed that the first frame image and the second frame image are successive frame images or adjacent frame images, and the points where the contour of the subject image is bent in the first frame image are first points and points where the contour of the subject image is bent in the second frame image are second points, the locations of the first points and the corresponding second points are compared with each other. As a result of the comparison, when the difference between at least one first point and the corresponding second point is equal to or greater than a predetermined degree, it may be determined that the movement of the subject is sensed. This has been described above with reference to FIGS. 3A through 3C.

In addition, the data values at the predetermined points in the first frame image and the data values at the points which are the same as the points of the first frame image in the second frame image are compared with each other. Thus, as a result of the comparison, when the difference between the data values of at least one predetermined point is equal to or greater than the predetermined value, it is determined that the movement of the subject is sensed. This has been described above with reference to FIGS. 4A and 4B.

As described above, in the digital moving picture photographing apparatuses, the methods of controlling the digital moving picture photographing apparatuses, and the computer readable recording medium having recorded thereon a program for executing any of the methods according to the present invention, unnecessary parts of the moving picture are not recorded during shooting and start/stop of the photographing may be performed automatically.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

What is claimed is:

1. A digital moving picture photographing apparatus comprising:
an image capture device for generating image data from incident light; and
a storage medium for storing the image data generated by the image capture device,
wherein, in a shooting mode, when a movement of a subject is sensed from frame images in the image data generated by the image capture device, storing of the image data of the frame images is started in the storage medium, and when the movement of the subject is not sensed from the frame images in the image data generated by the image capture device, during storing of the frame images in the storage medium, recording of the moving picture is stopped.

2. The digital moving picture photographing apparatus of claim 1, wherein a boundary image of the subject in a first frame image and a boundary image of the subject in a second frame image are compared with each other, and when there is a difference between the boundary images, it is determined that the movement of the subject is sensed, and when there is no difference between the boundary images, it is determined that the movement of the subject is not sensed.

3. The digital moving picture photographing apparatus of claim 2, wherein first points are defined as points where a contour line of the subject image in the first frame is bent, and second points are defined as points where a contour line of the subject image in the second frame is bent, and when locations of the first points and corresponding second points are compared with each other, and when a difference between at least one first point and the corresponding second point is equal to or greater than a predetermined degree, it is determined that the movement of the subject is sensed.

4. The digital moving picture photographing apparatus of claim 1, wherein data values at points which are set in advance in the first frame image and data values at points which are set in advance to correspond to the points of the first frame image in the second frame image are compared with each other, and when a difference between data values of at least one point is equal to or greater than a predetermined value, it is determined that the movement of the subject is sensed.

5. The digital moving picture photographing apparatus of claim 1, wherein in a shooting mode, even when the movement of the subject is sensed from the frame images of the image data generated by the image capture device, storing of the frame images data in the storage medium is started after a predetermined time period.

6. The digital moving picture photographing apparatus of claim 1, wherein in a shooting mode, after a predetermined time period, when the movement of subject is sensed from the frame images of the image data generated by the image capture device, storing of the frame image data in the storage medium is started.

7. A method of controlling a digital moving picture photographing apparatus comprising:
generating image data with an image capture device from incident light;
sensing movement of a subject from the frame images of image data generated by the image capture device in a shooting mode;
starting storing data of frame images when the movement of the subject is sensed; and
stopping recording of the moving picture when the movement of subject is not sensed during the storing of the frame images in the storage medium.

8. The method of claim 7, further comprising:
comparing a boundary image of the subject in a first frame image and a boundary image of the subject in a second frame image with each other;
determining that subject movement is sensed when there is a difference between the boundary images; and
determining that subject movement is not sensed when there is no difference between the boundary images.

9. The method of claim 8, further comprising:
defining first points as points where a contour line of the subject image in the first frame is bent;
defining second points as points where a contour line of the subject image in the second frame is bent;
comparing locations of the first points and corresponding second points with each other, and
determining that subject movement is sensed when a difference between at least one first point and the corresponding second point is equal to or greater than a predetermined degree.

10. The method of claim 7, further comprising:
comparing data values at points which are set in advance in the first frame image and data values at points which are set in advance to correspond to the points of the first frame image in the second frame image with each other; and
determining that subject movement is sensed when a difference between data values of at least one point is equal to or greater than a predetermined value.

11. The method of claim 7, wherein in a shooting mode, even when the movement of the subject from the frame images of the image data generated by the image capture device is sensed, starting storing of the frame images data in the storage medium after a predetermined time period.

12. The method of claim 7, wherein in a shooting mode, after a predetermined time period, when the movement of the subject is sensed from the frame images of the image data generated by the image capture device, starting storing of the frame image data in the storage medium.

13. A computer readable recording medium having embodied thereon computer readable program code adapted to be executed to implement a method for controlling a digital moving picture photographing apparatus, the method comprising:
generating image data with an image capture device from incident light;
storing the image data generated by the image capture device in a storage medium;
sensing movement of a subject from the frame images of image data generated by the image capture device in a shooting mode;
starting storing data of frame images when the movement of the subject is sensed; and
stopping recording of the moving picture when the movement of subject is not sensed during the storing of the frame images in the storage medium.

14. A method of determining a movement of a subject, the method comprising:
defining first points as points where a contour line of the subject image in the first frame is bent;
defining second points as points where a contour line of the subject image in the second frame is bent;
comparing locations of the first points and corresponding second points with each other; and
determining that the movement of the subject is sensed when a difference between at least one first point and the corresponding second point is equal to or greater than a predetermined degree.

15. A method of determining a movement of a subject, the method comprising:
comparing data values at points which are set in advance in the first frame image and data values at points which are set in advance to correspond to the points of the first frame image in the second frame image with each other; and
determining that subject movement is sensed when a difference between data values of at least one point is equal to or greater than a predetermined value.
